(19) United States
(12) Patent Application Publication
(10) Pub. No.: US 2013/0342789 A1
(43) Pub. Date: Dec. 26, 2013

(54) BACKLIGHT MODULE AND LIQUID CRYSTAL DISPLAY

(71) Applicants: Yanxue Zhang, Guangdong (CN); Yu-Chun Hsiao, Guangdong (CN)

(72) Inventors: Yanxue Zhang, Guangdong (CN); Yu-Chun Hsiao, Guangdong (CN)

(73) Assignee: Shenzhen China Star Optoelectronics Technology Co., Ltd., Guangdong (CN)

(21) Appl. No.: 13/636,172

(22) PCT Filed: Jul. 4, 2012
(86) PCT No.: PCT/CN2012/078146

§ 371 Date: Oct. 8, 2012

(30) Foreign Application Priority Data
Jun. 20, 2012 (CN) 201210204544.0

(51) Int. Cl. F21V 13/02; G02F 1/13357

(52) U.S. Cl. 349/65; 362/606

(57) ABSTRACT

The present invention discloses a backlight module comprising: a back plate having a side wall on an edge thereof; a light guide plate placed on the back plate; a light source placed on a side of the light guide plate; an optical sheet placed on the light guide plate; and a plastic housing that includes a first end and a second end; the first end has a pressing portion and the second end has a bending portion; the pressing portion contacts with the optical sheet and the bending portion has an extension portion in a first direction; and the extension portion contacts with the side wall of the back plate. The present invention further discloses a liquid crystal display (LCD).

### FIELD OF THE INVENTION

The present invention relates to the field of liquid crystal display (LCD) technology, and more particularly to a backlight module and a LCD.

### BACKGROUND OF THE INVENTION

In a backlight module of a traditional LCD, as shown in FIG. 1, a light source 30 is placed on a heat sink 60 and on a side of a light guide plate 40; while a back plate 70, the heat sink 60, a supporting component 50, the light guide plate 40 and an optical sheet 20 are stacked in turn from bottom to top. In the backlight module of the traditional LCD, the alignment of the light guide plate 40 with the light source 30 is realized by the following method: one end of a plastic housing 10 presses the optical sheet 20 that is on the light guide plate 40, and the other end thereof is coupled between the back plate 70 and a frame 80 of the backlight module.

With technological development, the light guide plate 40 used in the backlight module is getting thinner, but the thinner light guide plate 40 is, the more difficult the alignment with the light source 30 will be. Meantime, in the backlight module, the technical solution for the alignment of the light guide plate 40 with the light source 30 has the following shortcoming: the end where the plastic housing 10 presses the optical sheet 20 turns outward easily (the end where the plastic housing 10 is coupled to the external portion of the back plate 70 is defined as an axis, and the end where the plastic housing 10 presses the optical sheet 20 moves far away from the optical sheet 20), so that the light guide plate 40 misaligns with the light source 30, which easily resulting in light leakage at the incident side of the light guide plate 40, seriously affecting the light coupling efficiency of the backlight module and the display quality of the incident side of the LCD.

Also, because of light leakage of the light guide plate 40, in order to meet the requirement for the backlight brightness of the LCD, it takes more LEDs (light source 30) to generate back light, and thus increases manufacturing costs and energy consumption of the LCD.

Therefore, it is necessary to propose a new technique to solve the technical problems mentioned above.

### SUMMARY OF THE INVENTION

One object of the present invention is to provide a backlight module which can fix the light guide plate and the optical sheet, so as to decrease light leakage phenomenon.

To solve these problems, the present invention provides a backlight module comprising: a back plate having a side wall on an edge thereof; a light guide plate placed on the back plate; a light source placed on a side of the light guide plate; an optical sheet placed on the light guide plate; and a plastic housing that includes a first end and a second end, wherein the first end has a pressing portion and the second end has a bending portion; the pressing portion contacts with the optical sheet and the bending portion has an extension portion in a first direction; and the extension portion contacts with the side wall of the back plate.

In the backlight module, the first direction points to a plane where the bottom surface of the back plate is located from the second end; a first included angle is between the first direction and a line connecting the first end and the second end; and the first included angle is ranged from 30° to 150°.

In the backlight module, the side wall includes a third end and a fourth end; the fourth end is connected to the back plate, and a position where the extension portion contacts with the side wall is located between the third end and the fourth end.

In the backlight module, an external surface of the side wall has a first protrusion; an extended length of the extension portion is longer than or equal to a distance between the second end of the plastic housing and the first protrusion of the side wall, and a surface which the extension portion faces the side wall contacts with the first protrusion.

In the backlight module, a surface which the extension portion faces the side wall has a second protrusion; a distance between the second protrusion and the second end of the plastic housing is longer than or equal to a distance between the third end of the side wall and the second end of the plastic housing, and the second protrusion contacts with the external surface of the side wall.

Another object of the present invention is to provide a backlight module which can fix the light guide plate and the optical sheet, so as to decrease light leakage phenomenon.

To solve these problems, the present invention provides a LCD comprising a LCD panel; and a backlight module; wherein the backlight module comprises a back plate having a side wall on an edge thereof; a light guide plate placed on the back plate; a light source placed on a side of the light guide plate; an optical sheet placed on the light guide plate; and a plastic housing that includes a first end and a second end, wherein the first end has a pressing portion and the second end has a bending portion; the pressing portion contacts with the optical sheet and the bending portion has an extension portion in a first direction; and the extension portion contacts with the side wall of the back plate.

In the LCD, the first direction points to a plane where the bottom surface of the back plate is located from the second end; a first included angle is between the first direction and a line connecting the first end and the second end; and the first included angle is ranged from 30° to 150°.

In the LCD, the side wall includes a third end and a fourth end; the fourth end is connected to the back plate, and a position where the extension portion contacts with the side wall is located between the third end and the fourth end.

In the LCD, an external surface of the side wall has a first protrusion; an extended length of the extension portion is longer than or equal to a distance between the second end of the plastic housing and the first protrusion of the side wall, and a surface which the extension portion faces the side wall contacts with the first protrusion.

In the LCD, a surface which the extension portion faces the side wall has a second protrusion; a distance between the second protrusion and the second end of the plastic housing is longer than or equal to a distance between the third end of the side wall and the second end of the plastic housing, and the second protrusion contacts with the external surface of the side wall.

Compared to the traditional technology, the second end of the plastic housing includes the bending portion that has the extension portion in the first direction pointing to a plane where the bottom surface of the back plate is located from the second end; the first included angle, between the first direction and the line connecting the first end and the second end, is ranged from 30° to 150°; and the extension portion contacts with the side wall of the back plate. Specifically, the external surface of the side wall of the back plate has the first protrusion which the extension portion of the plastic housing contacts with; or the surface which the extension portion faces the side wall has the second protrusion which the side wall contacts with. Therefore, the plastic housing of the backlight module of the present invention does not easily turn outward, that is, the pressing portion of the plastic housing does not easily turn to the direction far away from the optical sheet along with the bending portion, thus it relatively fix the optical sheet and the light guide plate, which decreases the gap between the pressing portion of the plastic housing and the optical sheet. The fixation of the optical sheet and the light guide plate is advantageous to prevent light leakage at the incident side of the backlight module, so as to improve the light coupling efficiency among the light source, the light guide plate and the optical sheet of the backlight module, and improve the display quality of the LCD. Additionally, because of the improvement of the light coupling efficiency, under the same requirement of the light brightness, the present invention uses fewer

LEDs as the light source, which reduces manufacturing costs and energy consumption of the LCD and backlight module of the present invention.

For the present invention described above will be more apparent, the following specific preferred embodiment with the companying drawings will be elaborated, as follows:

### DESCRIPTION OF THE DRAWINGS

FIG. 1 is a partially schematic view showing a backlight module of a traditional LCD;

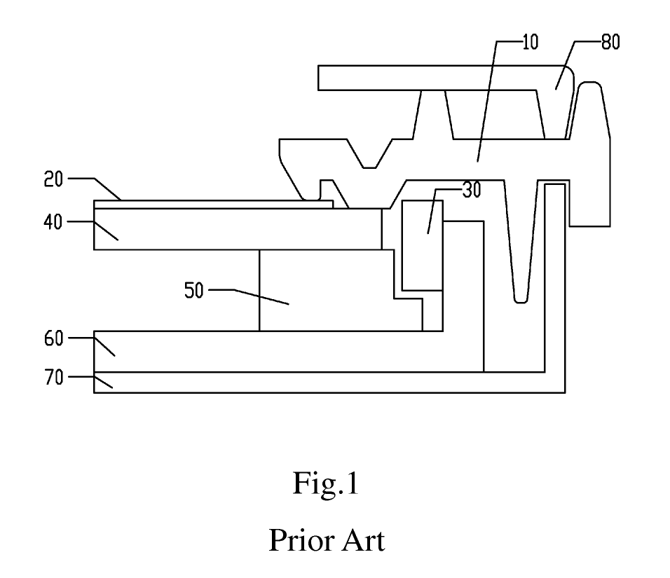

FIG. 2 is a partially schematic view showing a first embodiment of a backlight module of the present invention;

FIG. 3 is a partially schematic view showing a second embodiment of a backlight module of the present invention;

FIG. 4 is a partially schematic view showing a first embodiment of a LCD of the present invention; and

FIG. 5 is a partially schematic view showing a second embodiment of a LCD of the present invention.

### DETAILED DESCRIPTION OF THE PREFERRED EMBODIMENTS

The structure and the technical means adopted by the present invention to achieve the above and other objects can be best understood by referring to the following detailed description of the preferred embodiments and the accompanying drawings.

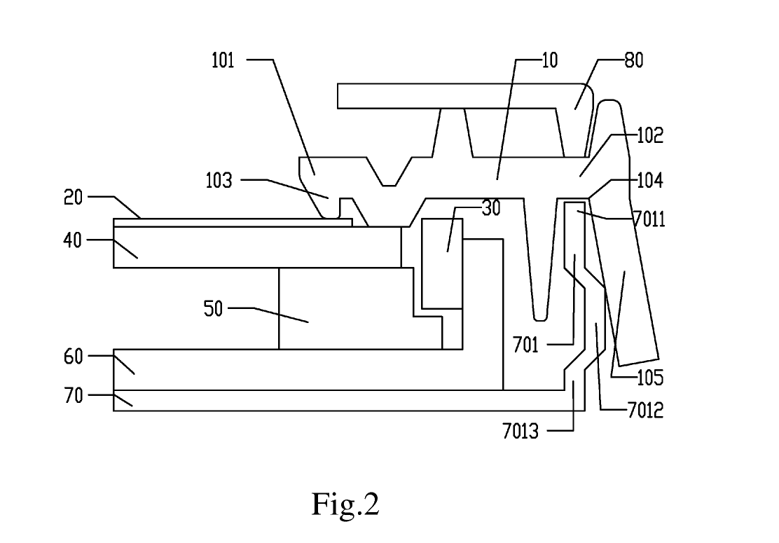

Please refer to FIG. 2, a partially schematic view showing a first embodiment of a backlight module of the present invention is illustrated. In this embodiment, a backlight module of the present invention comprises a back plate 70, a heat sink 60, a supporting component 50, a light guide plate 40, a light source 30, an optical sheet 20, a plastic housing 10 and a frame 80. The back plate 70 has a side wall 701 on an edge thereof; the light guide plate 40 is placed on the back plate 70; the light source 30 is placed on the side of the light guide plate 40; the optical sheet is placed on the light guide plate 40; and the plastic housing 10 is placed on the optical sheet 20 and the side wall 701 of the back plate 70. The plastic housing 10 includes a first end 101 and a second end 102; the first end 101 is place on the optical sheet 20; specifically, the first end 101 of the plastic housing 10 has a pressing portion 103 which contacts with the optical sheet 20; specifically, the pressing portion 103 is used to press the optical sheet 20 and the light guide plate 40, so as to fix the optical sheet 20 and the light guide plate 40.

Furthermore, the second end 102 of the plastic housing 10 is close to the side wall 701; specifically, the second end 102 of the plastic housing 10 has a bending portion 104; the bending portion 104 has an extension portion 105 in a first direction; and the extension 105 contacts with the side wall 701 of the back plate 70. The first direction points to a plane where the bottom surface of the back plate 70 is located from the second end 102; a first included angle is between the first direction and a line connecting the first end 101 and the second end 102; the first included angle is ranged from 30° to 150°. The side wall 701 includes a third end 7011 and a fourth end 7013; the fourth end 7013 is connected to an edge of the back plate 70, that is, the fourth end 7013 of the side wall 701 is an extension of the back plate 70 in a second direction which points to the plastic housing 10 from an edge of the back plate 70. A second included is angle is between the second direction and a line connecting the third end 7011 and the fourth end 7013; the second included angle is ranged from 30° to 150°. In this embodiment, the second included angle is a right angle, and the line connecting the first end 101 and the second end 102 of the plastic housing 10 is parallel to the bottom surface of the back plate 70. The first included angle is greater than the second included angle.

Besides, the third end 7011 of the side wall 701 is close to the inner surface of the bending portion 104 of the plastic housing 10. A position where the extension portion 105 of the plastic housing 10 contacts with the side wall 701 is located between the third end 7011 and the fourth end 7013 of the side wall 701. Specifically, an external surface of the side wall 701 has a first protrusion 7012, and the extension portion 105 contacts with the first protrusion 7012. The extended length of the extension portion 105 is longer than or equal to the distance between the second end 102 of the plastic housing 10 and the center of the external surface of the first protrusion 7012 of the side wall 701. The surface which the extension portion 105 faces the side wall 701 contacts with the first protrusion 7012. The first protrusion 7012 of the side wall 7012 is between the third end 7011 and the fourth end 7013, and the external surface of the side wall 701 is the surface that the side wall 701 faces the light source 30. The first protrusion 7012 can be formed by stamping the side wall 701 from the surface (inner surface) that the side wall 701 faces the light source 30 to the surface (external surface) that the side wall 701 turns backward.

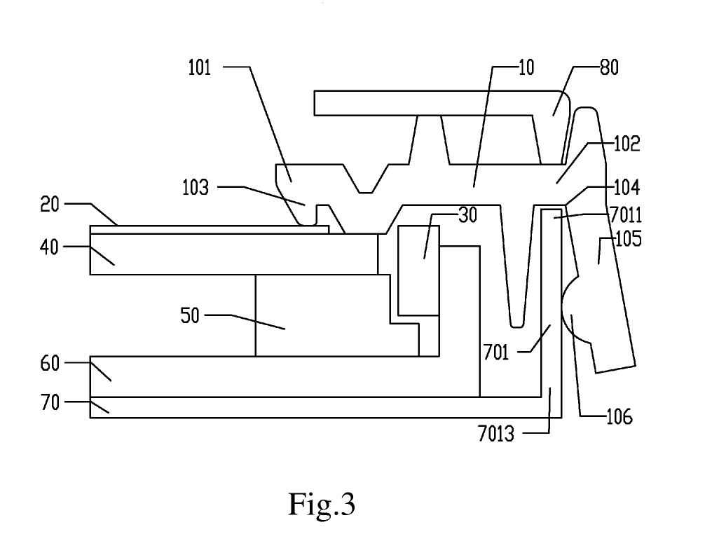

Please refer to FIG. 3, a partially schematic view showing a second embodiment of a backlight module of the present invention is illustrated. The identical part of this embodiment and the foregoing embodiment will not be described again. In this embodiment, the bending portion 104 of the plastic housing 10 has the extension portion 105 in the first direction, and the extension portion 105 contacts with the side wall 701 of the back plate 70. The position where the extension portion 105 of the plastic housing 10 contacts with the side wall 701 is located between the third end 7011 and the fourth end 7013 of the side wall 701. Specifically, the surface of the side wall 701 that the extension portion 105 faces has the second protrusion 106 which contacts with the side wall 701. The extended length of the extension portion 105 is longer than or equal to the distance between the second end 102 of the plastic housing 10 and the third end 7011 of the side wall 701. The second protrusion 106 of the extension portion 105 contacts with the external surface (the surface backward to the light source 30) of the side wall 701. The position where the side wall 7012 contacts with the second protrusion 106 is located between the third end 7011 and the fourth end 7013.

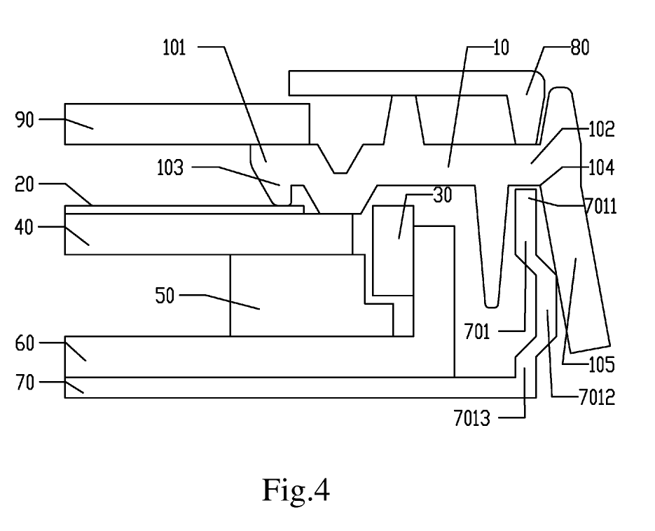

A LCD of the present invention comprises a LCD panel 90 and the backlight module, the LCD panel 90 and the backlight module are layered as the LCD of the present invention, as shown in FIG. 4. In the first embodiment of the LCD of the present invention, the backlight module comprises the back plate 70, the heat sink 60, the supporting component 50, the light guide plate 40, the light source 30, the optical sheet 20, the plastic housing 10 and the frame 80. The back plate 70 has the side wall 701 on the edge thereof; the light guide plate 40 is placed on the back plate 70; the light source 30 is placed on the side of the light guide plate 40; the optical sheet is placed on the light guide plate 40; and the plastic housing 10 is placed on the optical sheet 20 and the side wall 701 of the back plate 70. The plastic housing 10 includes the first end 101 and the second end 102; the first end 101 is place on the optical sheet 20; specifically, the first end 101 of the plastic housing 10 has the pressing portion 103 which contacts with the optical sheet 20; specifically, the pressing portion 103 is used to press the optical sheet 20 and the light guide plate 40, so as to fix the optical sheet 20 and the light guide plate 40.

Furthermore, the second end 102 of the plastic housing 10 is close to the side wall 701; specifically, the second end 102 of the plastic housing 10 has the bending portion 104; the bending portion 104 has the extension portion 105 in the first direction; and the extension 105 contacts with the side wall 701 of the back plate 70. The first direction points to the plane where the bottom surface of the back plate 70 is located from the second end 102; the first included angle is between the first direction and the line connecting the first end 101 and the second end 102; the first included angle is ranged from 30° to 150°. The side wall 701 includes the third end 7011 and the fourth end 7013; the fourth end 7013 is connected to the edge of the back plate 70, that is, the fourth end 7013 of the side wall 701 is the extension of the back plate 70 in the second direction which points to the plastic housing 10 from the edge of the back plate 70. The second included is angle is between the second direction and the line connecting the third end 7011 and the fourth end 7013; the second included angle is ranged from 30° to 150°. In this embodiment, the second included angle is a right angle, and the line connecting the first end 101 and the second end 102 of the plastic housing 10 is parallel to the bottom surface of the back plate 70. The first included angle is greater than the second included angle.

Besides, the third end 7011 of the side wall 701 is close to the inner surface of the bending portion 104 of the plastic housing 10. The position where the extension portion 105 of the plastic housing 10 contacts with the side wall 701 is located between the third end 7011 and the fourth end 7013 of the side wall 701. Specifically, the external surface of the side wall 701 has the first protrusion 7012, and the extension portion 105 contacts with the first protrusion 7012. The extended length of the extension portion 105 is longer than or equal to the distance between the second end 102 of the plastic housing 10 and the center of the external surface of the first protrusion 7012 of the side wall 701. The surface which the extension portion 105 faces the side wall 701 contacts with the first protrusion 7012. The first protrusion 7012 of the side wall 7012 is between the third end 7011 and the fourth end 7013, and the external surface of the side wall 701 is the surface that the side wall 701 faces the light source 30. The first protrusion 7012 can be formed by stamping the side wall 701 from the surface (inner surface) that the side wall 701 faces the light source 30 to the surface (external surface) that the side wall 701 turns backward.

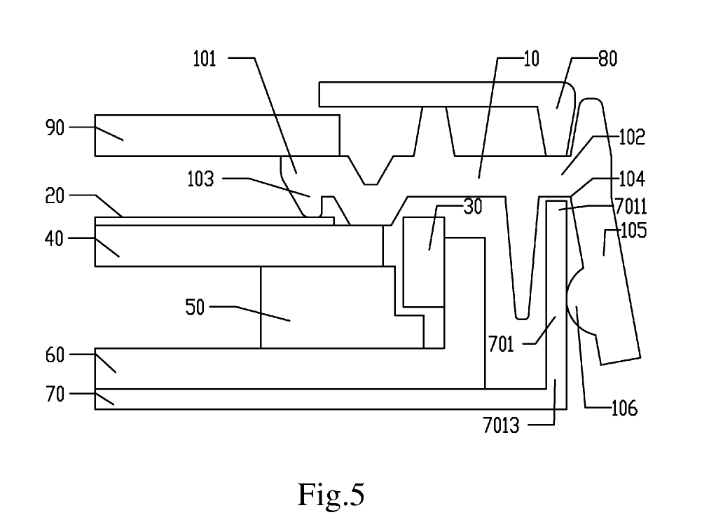

As shown in FIG. 5, a partially schematic view showing a second embodiment of a LCD of the present invention is illustrated. The identical part of this embodiment and the foregoing embodiment will not be described again. In this embodiment, the bending portion 104 of the plastic housing 10 has the extension portion 105 in the first direction, and the extension portion 105 contacts with the side wall 701 of the back plate 70. The position where the extension portion 105 of the plastic housing 10 contacts with the side wall 701 is located between the third end 7011 and the fourth end 7013 of the side wall 701. Specifically, the surface of the side wall 701 that the extension portion 105 faces has the second protrusion 106 which contacts with the side wall 701. The extended length of the extension portion 105 is longer than or equal to the distance between the second end 102 of the plastic housing 10 and the third end 7011 of the side wall 701. The second protrusion 106 of the extension portion 105 contacts with the external surface (the surface backward to the light source 30) of the side wall 701. The position where the side wall 7012 contacts with the second protrusion 106 is located between the third end 7011 and the fourth end 7013.

In the present invention, the second end 102 of the plastic housing 10 includes the bending portion 104 that has the extension portion 105 in the first direction pointing to the plane where the bottom surface of the back plate 70 is located from the second end 102; the first included angle, between the first direction and the line connecting the first end 101 and the second end 102, is ranged from 30° to 150°; and the extension portion 105 contacts with the side wall 701 of the back plate 70. Specifically, the external surface of the side wall 701 of the back plate 70 has the first protrusion 7012 which the extension portion 105 of the plastic housing 10 contacts with; or the surface which the extension portion 105 faces the side wall 701 has the second protrusion 106 which the side wall contacts with. Therefore, the plastic housing 10 of the backlight module of the present invention does not easily turn outward, that is, the pressing portion 103 of the plastic housing 10 does not easily turn to the direction far away from the optical sheet 20 along with the bending portion 104, thus it relatively fix the optical sheet 20 and the light guide plate 40, which decreases the gap between the pressing portion 103 of the plastic housing 10 and the optical sheet 20. The fixation of the optical sheet 20 and the light guide plate 40 is advantageous to prevent light leakage at the incident side of the backlight module, so as to improve the light coupling efficiency among the light source 30, the light guide plate 40 and the optical sheet 20 of the backlight module, and improve the display quality of the LCD. Additionally, because of the improvement of the light coupling efficiency, under the same requirement of the light brightness, the present invention uses fewer LEDs as the light source, which reduces manufacturing costs and energy consumption of the LCD and backlight module of the present invention.

The present invention has been described with a preferred embodiment thereof and it is understood that many changes and modifications to the described embodiment can be carried out without departing from the scope and the spirit of the invention that is intended to be limited only by the appended claims.

What is claimed is:

1. A backlight module, comprising:
a back plate having a side wall on an edge thereof;
a light guide plate placed on the back plate;
a light source placed on a side of the light guide plate;
an optical sheet placed on the light guide plate; and
a plastic housing that includes a first end and a second end, wherein the first end has a pressing portion and the second end has a bending portion; the pressing portion contacts with the optical sheet and the bending portion has an extension portion in a first direction; and the extension portion contacts with the side wall of the back plate;
wherein the first direction points to a plane where a bottom surface of the back plate is located from the second end; a first included angle is between the first direction and a line connecting the first end and the second end; and the first included angle is ranged from 30° to 150°; and
wherein the side wall includes a third end and a fourth end; the fourth end is connected to the back plate, and a position where the extension portion contacts with the side wall is located between the third end and the fourth end; the fourth end of the side wall is connected to the edge of the back plate; and the third end of the side wall is close to an inner surface of the bending portion of the plastic housing.

2. The backlight module according to claim 1, wherein an external surface of the side wall has a first protrusion.

3. The backlight module according to claim 2, wherein an extended length of the extension portion is longer than or equal to a distance between the second end of the plastic housing and the first protrusion of the side wall, and a surface which the extension portion faces the side wall contacts with the first protrusion.

4. The backlight module according to claim 1, wherein a surface which the extension portion faces the side wall has a second protrusion.

5. The backlight module according to claim 4, wherein a distance between the second protrusion and the second end of the plastic housing is longer than or equal to a distance between the third end of the side wall and the second end of the plastic housing, and the second protrusion contacts with the external surface of the side wall.

6. A backlight module, comprising:
a back plate having a side wall on an edge thereof;
a light guide plate placed on the back plate;
a light source placed on a side of the light guide plate;
an optical sheet placed on the light guide plate; and
a plastic housing that includes a first end and a second end, wherein the first end has a pressing portion and the second end has a bending portion; the pressing portion contacts with the optical sheet and the bending portion has an extension portion in a first direction; and the extension portion contacts with the side wall of the back plate.

7. The backlight module according to claim 6, wherein the first direction points to a plane where a bottom surface of the back plate is located from the second end; a first included angle is between the first direction and a line connecting the first end and the second end; and the first included angle is ranged from 30° to 150°.

8. The backlight module according to claim 7, wherein the side wall includes a third end and a fourth end; the fourth end is connected to the back plate, and a position where the extension portion contacts with the side wall is located between the third end and the fourth end.

9. The backlight module according to claim 8, wherein an external surface of the side wall has a first protrusion; an extended length of the extension portion is longer than or equal to a distance between the second end of the plastic housing and the first protrusion of the side wall, and a surface which the extension portion faces the side wall contacts with the first protrusion.

10. The backlight module according to claim 8, wherein a surface which the extension portion faces the side wall has a second protrusion; a distance between the second protrusion and the second end of the plastic housing is longer than or equal to a distance between the third end of the side wall and the second end of the plastic housing, and the second protrusion contacts with the external surface of the side wall.

11. A liquid crystal display (LCD), comprising:
a LCD panel; and
a backlight module;
wherein the backlight module comprises:
a back plate having a side wall on an edge thereof;
a light guide plate placed on the back plate;
a light source placed on a side of the light guide plate;
an optical sheet placed on the light guide plate; and
a plastic housing that includes a first end and a second end, wherein the first end has a pressing portion and the second end has a bending portion; the pressing portion contacts with the optical sheet and the bending portion has an extension portion in a first direction; and the extension portion contacts with the side wall of the back plate.

12. The LCD according to claim 11, wherein the first direction points to a plane where a bottom surface of the back plate is located from the second end; a first included angle is between the first direction and a line connecting the first end and the second end; and the first included angle is ranged from 30° to 150°.

13. The LCD according to claim 12, wherein the side wall includes a third end and a fourth end; the fourth end is connected to the back plate, and a position where the extension portion contacts with the side wall is located between the third end and the fourth end.

14. The LCD according to claim 13, wherein an external surface of the side wall has a first protrusion; an extended length of the extension portion is longer than or equal to a distance between the second end of the plastic housing and the first protrusion of the side wall, and a surface which the extension portion faces the side wall contacts with the first protrusion.

15. The LCD according to claim 13, wherein a surface which the extension portion faces the side wall has a second protrusion; a distance between the second protrusion and the second end of the plastic housing is longer than or equal to a distance between the third end of the side wall and the second end of the plastic housing, and the second protrusion contacts with the external surface of the side wall.
